(19) United States
(12) Patent Application Publication
(10) Pub. No.: US 2025/0156899 A1
(43) Pub. Date: May 15, 2025

(54) MULTICHANNEL IN-CLUB ATTRIBUTION SYSTEM FOR FEATURED ITEMS

(71) Applicant: Walmart Apollo, LLC, Bentonville, AR (US)

(72) Inventors: Sachin Khanna, Dublin, CA (US); Shivank Garg, Bengaluru (IN); Venkatraman Ur, Mountain House, CA (US); Vikram Nag Ashoka, Santa Clara, CA (US); Anant Furia, San Jose, CA (US); Shravya Maranganti, San Bruno, CA (US)

(21) Appl. No.: 18/506,972

(22) Filed: Nov. 10, 2023

(51) Int. Cl. G06Q 30/0242; G06Q 30/0241

(52) U.S. Cl. CPC G06Q 30/0246; G06Q 30/0247

(57) ABSTRACT

Examples provide for multichannel attribution of member-related offline purchase data with member-related online activity data associated with a featured item entry for an item featured on a webpage. An attribution manager correlates the offline purchase data associated with the featured item and items related to the featured item with the online activity data, such as views and clicks associated with the featured item entry. The attribution manager generates a multichannel attribution report including multichannel attribution data, including attribution level data and time window data. The attribution level data includes direct attribution data, complementary item attribution data and common brand attribution data. The time window data includes identification of a time window during which member purchase of instances of the featured item take place subsequent to member online activity associated with the featured item. The attribution report is presented to users via a user interface device.

### BACKGROUND

Producers and manufacturers of products frequently wish to advertise or promote their products to inform the public about their product and increase sales of their products. Some systems can track online purchase of products and correlate those online sales with sponsored advertising clicked by the user earlier in the user's online journey. Correlating online views of advertisements with subsequent online purchases of the advertised products can generally be accomplished. However, these solutions are typically unable to accurately correlate offline purchases made within brick-and-mortar stores with a user's views and clicks on online advertising due to an inability to obtain accurate offline purchase data. Thus, any predictions regarding a user's in-store purchases influenced by earlier viewing of online promotional materials by the user are inaccurate and unreliable.

### SUMMARY

Some examples provide a system for multichannel in-club attribution. The system includes a processor; and a computer-readable medium storing instructions that are operative upon execution by the processor to monitor online activity associated with a featured item entry within a webpage by a plurality of members. The online activity includes featured item entry views and featured item entry clicks. The system obtains multichannel purchase data for a set of attributable items associated with the featured item from a data store using a member identifier (ID) for each member in the plurality of members. The set of attributable items includes the featured item and a set of items related to the featured item. The multichannel purchase data includes offline purchase data. The system correlates the online activity with the multichannel purchase data for the set of attributable items. The system creates a multichannel attribution report including multichannel attribution data associated with purchases of instances of items in the set of attributable items by the plurality of members correlated with the online activity of the plurality of members. The multichannel attribution report is presented to a user via a user interface device.

Other examples provide a method for multichannel in-club attribution. An attribution manager monitors online activity associated with a featured item by a plurality of members of a retail club. The featured item associated with a featured item entry within a webpage. Online activity data describing the monitored online activity associated with the featured item entry is generated. The monitored online activity includes a number of views of the featured item entry and a number of clicks on the featured item entry by one or more members in the plurality of members occurring within a predetermined time-period. The attribution manager obtains multichannel purchase data for a set of attributable items associated with the featured item. The set of attributable items includes the featured item and a set of items related to the featured item. The multichannel purchase data includes offline purchase data. The online activity data is correlated with the multichannel purchase data for the set of attributable items. The attribution manager generates multichannel attribution data associated with the featured item describing online activity correlated with purchase of instances of items in the set of attributable items. The attribution manager creates a multichannel attribution report. The report describes item purchases attributable to the featured item entry across multiple purchase channels. The multichannel attribution report is presented to a user via a user interface device.

Still other examples provide a computer storage devices having computer-executable instructions stored thereon, which, upon execution by a computer, cause the computer to perform operations including monitoring online activity associated with a featured item by a plurality of members of a retail club; generating online activity data describing the monitored online activity associated with the featured item entry; obtaining multichannel purchase data for a set of attributable items associate with the featured item; generating multichannel attribution data associated with the featured item describing online activity correlated with purchase of instances of items in the set of attributable items; generating a multichannel attribution report describing item purchases attributable to the featured item entry across multiple purchase channels; and presenting the multichannel attribution report to a user via a user interface device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for multichannel attribution using member-related online activity data and purchase data.

FIG. 2 is an exemplary block diagram illustrating a system for multichannel attribution using member-related data associated with members of a retail club.

FIG. 3 is an exemplary block diagram illustrating a retail facility associated with offline purchase of items by members.

FIG. 4 is an exemplary block diagram illustrating a user device including a user interface (UI) for displaying a multichannel attribution report.

FIG. 5 is an exemplary block diagram illustrating an attribution manager for correlating multichannel purchase data with member-related online activity data.

FIG. 6 is an exemplary flow chart illustrating operation of the computing device to generate multichannel attribution reports.

FIG. 7 is an exemplary flow chart illustrating operation of the computing device for attribution of multichannel purchase data with member-related online activity data.

FIG. 8 is an exemplary diagram illustrating a multichannel attribution report.

FIG. 9 is an exemplary table illustrating total attributed sales revenue associated with a featured item.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

A digital advertisement attribution system works by correlating customer's purchases to the clicks they have performed earlier in their online journey, prior to making the purchases. The purchase data and online activity are monitored while the user is online. However, purchases made by the customer while in a brick-and-mortar retail facility (offline) are typically unavailable. In some situations, some information may be obtained regarding offline purchases, such as obtaining information from credit card purchases or purchases made with a reward card which records some offline purchases. However, this offline purchase information is limited to purchases made with a specific credit card or reward card. The offline purchase information remains unavailable where a customer uses cash or lacks a rewards account. Thus, offline purchase data is typically incomplete or unavailable, limiting accurate promotional product attributions to online purchases. This problem of inaccurate attribution of purchase data to sponsored products is addressed via an attribution manager which correlates multichannel online activity by members of a retail club with member-related multichannel purchase data to generate accurate and complete promotional products attributions.

Referring to the figures, examples of the disclosure enable a multichannel attribution system which enables attribution for featured items purchased via both online and offline purchase channels. In some examples, the system tracks and correlates purchases made in physical retail locations (in-club), such as brick and mortar retail facilities. The system correlates purchases made via all offline purchase channels, including staffed point of sale (POS) checkout devices as well as scan and go (SNG) self-checkout devices within one or more retail facilities. Thus, the system more accurately identifies purchases made as a result of a user clicking ads or other promotional materials seen by the customer earlier in the user's online journey. This enables users to maximize revenue spent on promotions and featured items, such as sponsored products displayed for viewing and/or clicking by users on the online platform.

Aspects of the disclosure further enable obtaining multichannel purchase data for a set of attributable items associated with the featured item from a data store using a member identifier (ID) for each member in a plurality of members for a member only retail club. The set of attributable items includes the featured item and a set of one or more items related to the featured item. The multichannel purchase data includes both online purchase data and offline purchase data. The offline purchase data is obtained from member purchase data stored in a data store by the retail club. This enables accurate and complete purchase data for items purchased by users subsequently to viewing or clicking on a featured item entry online. The offline purchase data is maintained in a data store accessible by the attribution manager. This further enables reducing network bandwidth usage and increasing accuracy and completeness of the purchase data used for attribution of purchases of featured items by member to online activity of members.

Other examples include an attribution manager that correlates the online activity of members with the multichannel purchase data for the set of attributable items. The multichannel purchase data includes data for both online and offline purchases of items made by members of the retail club. This enables more accurate and complete attribution which accounts for all purchase channels, including in-club purchases made at a brick-and-mortar retail club facility for reduced error rate in attribution data and improved efficiency in obtaining accurate purchase data.

The system in other examples creates a multichannel attribution report including multichannel attribution data associated with purchases of instances of items in the set of attributable items by the plurality of members correlated with the online activity of the plurality of members. The attribution report provides more accurate and complete return on ad spend (ROAS) data including both online purchase as well as offline purchase attribution. In other examples, the report includes attribution levels and/or attribution window data associated with the multichannel attribution presented to the user via a user interface (UI). This enables improved user efficiency via the UI interaction and increased user interaction performance where all the attribution data for multiple purchase channels is available in a single report.

The computing device operates in an unconventional manner by using member-related purchase data and member-related online activity associated with each member identifier (ID) to generate more accurate multichannel purchase attribution data for featured items promoted online. All the member-related data is available to the system enabling reduced system resource usage and decreased processing time (increased speed), thereby improving the functioning of the underlying computing device.

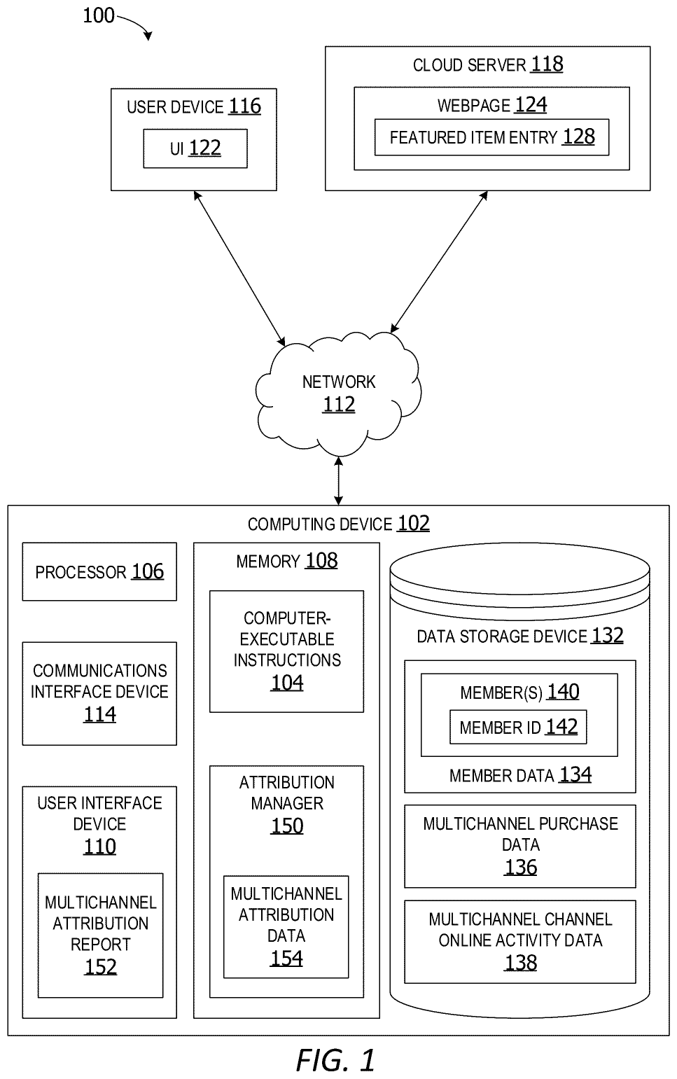

Referring again to FIG. 1, an exemplary block diagram illustrates a system 100 for multichannel attribution using member-related online activity data and purchase data. In the example of FIG. 1, the computing device 102 represents any device capable of executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

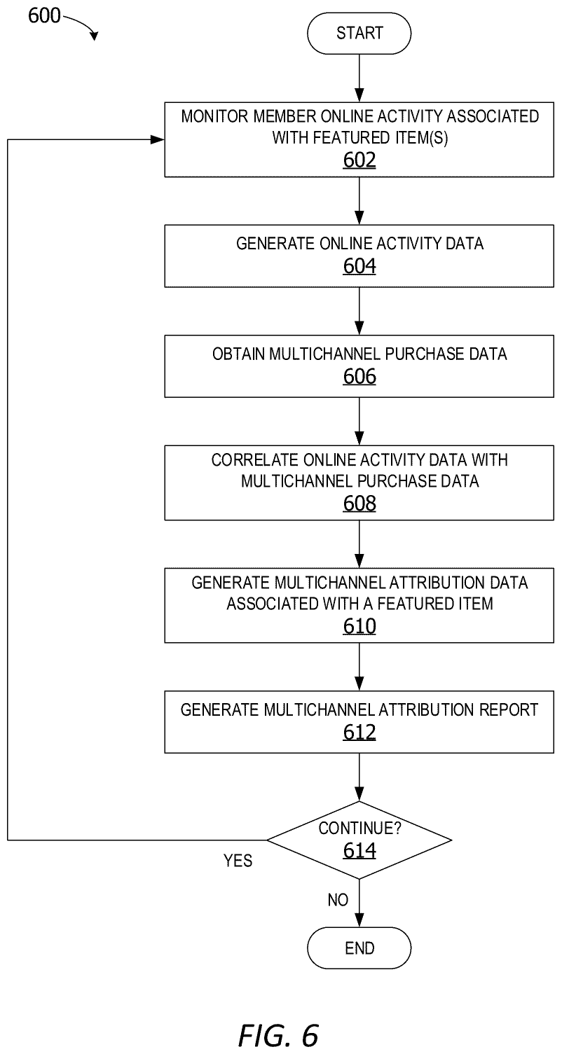

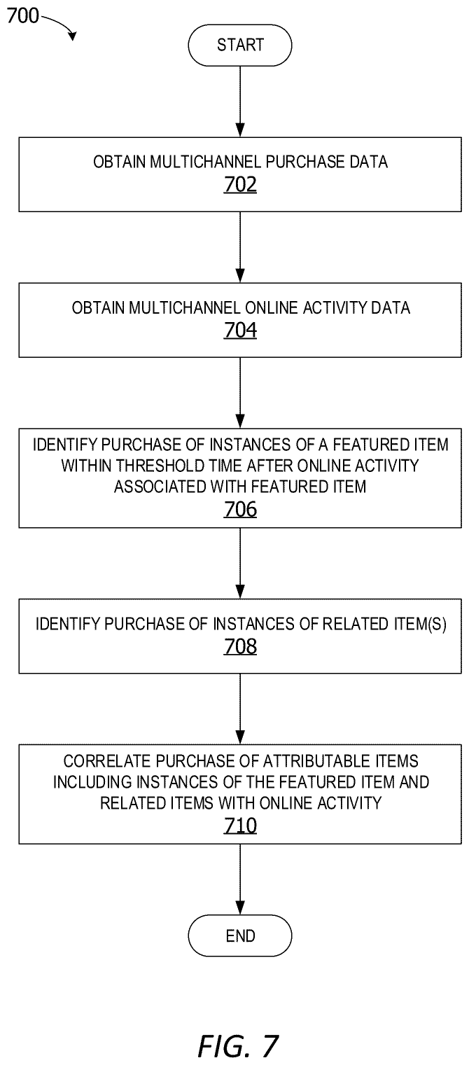

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIGS. 6 and 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118 can occur using any protocol or mechanism over any wired or wireless connection. In some examples, the communications interface device 114 is operable with short range communication technologies such as by using near-field communication (NFC) tags.

The user device 116 represents any device capable of executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 122.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In this example, the cloud server 118 is a web server hosting a webpage 124 associated with a retail club. A retail club is a commercial establishment providing retail items for sale to club members, such as, but not limited to, a store which only permits club members to purchase items offered for sale by the retail club. The webpage 124 includes a plurality of entries associated with a plurality of items offered for sale by the retail club. A user views the item entries via a UI on a user device, such as, but not limited to, the UI 122 on the user device 116. The user device accesses the webpage 124 via the network 112. The webpage includes a featured item entry 128 associated with a featured item.

A featured item is an item which is being promoted, highlighted, or otherwise given prominence on the webpage and/or in search results presented to a user via the UI 122 on the user device 116 in response to a user query or search terms. A featured item may be referred to as a sponsored product. A seller, manufacturer or distributor of an item typically pays a fee for an item to be featured on the webpage 124 and/or in the search results. For example, in response to a user search for soft drinks, a featured item soda brand is presented as the first search result or with the first row of search results. In other examples, one or more featured items are displayed in the first two rows of products returned in response to a search. In other examples, the item entry for a featured item is moved from its original position in the UI to a first slot or first row of search results such that the featured item entry is viewed first in the UI. In this manner, a user first views the featured item entries. A featured item entry 128 can be clicked on (selected) by the user. When clicked on, the UI 122 displays a product page containing more detailed information regarding the featured item. Thus, the featured item entry is viewable and clickable by users.

In some examples, the webpage includes a plurality of item entries displayed in rows and/or columns. Each item entry optionally includes an image of the item and a name of the item. The item entry optionally also includes a price, sizing information, variety information and/or other information regarding the product. The image of the product may be referred to as a “thumbnail” image.

The featured item entry in some examples includes an indicator identifying the item as a featured item. In one example, the featured item entry includes the words “sponsored item” in text displayed in proximity to the item. In one example, the words “featured item” or “sponsored item” is printed below the image of the featured item. In other examples, the featured item entry is displayed in a larger size, with a different border, or other indicator such that the featured item entry is more prominent than other non-featured items.

In other examples, the item entries are displayed in one or more rows. In these examples, the featured item entry is presented as the first item entry in the first row of item entries presented on the webpage or other search results page. In other examples, if there are two or more featured item entries, the featured item entries are presented within the first row and/or the second row such that the first item entries viewed by the member are seen first when reviewing search results for a product, type of product, etc.

The data store is a data storage component that is capable of storing multichannel attribution data 154 associated with one or more featured items, such as, but not limited to, the data storage device 132. The multichannel attribution data 154 includes attribution of both online purchases and offline (in-store) purchases of items correlated with online activity by a user, such as online clicks and/or views of featured item entries on the webpage 124 or within an application on the user device 116.

The system 100 can optionally include a data storage device 132 for storing data, such as, but not limited to member data 134, multichannel purchase data 136 and/or multichannel online activity data 138. The member data 134 is information data associated with one or more members in a plurality of member(s) 140 associated with the retail club. The member data 134 in some examples includes member account information, such as member name, member address, member phone number, member email address, etc. Each member in the plurality of members is assigned a member identifier (ID) 142. Each member is associated with a unique member ID. The member ID is used to monitor member online activity and member purchases made online as well as purchases made offline in a brick-and-mortar retail facility (store) associated with the retail club.

The multichannel purchase data 136 is information associated with a plurality of purchase channels. In this example, the multichannel purchase data 136 includes online purchase information associated with purchase of items made online via a webpage or application. The online purchase data includes information associated with purchases made using a desktop computer, laptop computer, mobile computing device, or any other type of device, such as, but not limited to, the user device 116.

The multichannel purchase data 136 includes offline purchase information describing items purchased offline by the user, such as purchases made in brick-and-mortar stores. The offline purchase data includes items purchased via a staffed point of sale (POS) checkout device as well as purchases made via unmanned, self-checkout devices.

The multichannel online activity data 138 is information describing online activity of members. The online activity includes views of featured item entries as well as clicks on featured item entries, such as the featured item entry 128. The multichannel online activity data 138 includes data from associated with online activity via a webpage, application, or any other source of online activity.

The data storage device 132 can include one or more different types of data storage devices, such as, for example, one or more rotating disks drives, one or more solid state drives (SSDs), and/or any other type of data storage device. The data storage device 132, in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 132 includes a database.

The data storage device 132 in this example is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components. The attribution manager 150 is a software component for generating multichannel attribution data 154 and/or a multichannel attribution report 152. In some examples, the attribution manager 150 monitors online activity associated with the featured item entry 128 within the webpage 124 by one or more member(s) 140. The online activity includes featured item entry views and featured item entry clicks. The attribution manager 150 obtains the multichannel purchase data 136 for a set of one or more attributable items. The multichannel purchase data 136 is obtained from the data storage device 132 in this example. In other examples, the multichannel purchase data 136 is pulled from a remote data store via the network, such as, but not limited to, a cloud storage.

The multichannel purchase data 136 is information describing purchases made by members. The data is gathered from online and offline sources of purchase data using the member identifier (ID) for each member in the plurality of members. In other words, each time a member purchases an item online or offline, the purchase data for that purchase is stored with the member ID of the member making the purchase. The purchase data includes, for example, but without limitation, the date of purchase, type of item, item brand, variety, size, weight, price, universal product code (UPC) for the item, as well as any other purchase data.

The set of attributable items includes the featured item and/or a set of one or more items related to the featured item. A related item is an item that is different from the featured item, but related in such a manner that a user viewing the featured item entry might be influenced to purchase the related item in addition to the featured item or instead of the featured item. A related item includes items of the same type and brand as the featured item but a different variety. For example, if the user views a featured item entry for a regular variety soft drink of a brand A that includes sugar in the ingredients but later purchases a diet variety of the same item type soft drink from the same brand A that does not include sugar, this is a common brand different variety type of related item.

A complementary item is a related item that is a type of item different from the featured item which is frequently purchased in combination with the featured item. For example, if the featured item is milk, then a complementary item is cereal. Cereal is a different type of item than the milk, but cereal and milk are frequently purchased together or used together. In another example, a complementary item for shampoo is condition. Likewise, a complementary item for peanut butter is jelly.

The attribution manager 150 correlates the multichannel online activity data 138 describing member online activity associated with one or more featured items with the multichannel purchase data 136 describing online and offline purchases of attributable items. The attributable items include the one or more featured items and one or more related items associated with the one or more featured items.

The attribution manager 150, in other examples, creates a multichannel attribution report 152 including multichannel attribution data 154 associated with purchases of instances of items in the set of attributable items by the plurality of members correlated with the online activity of one or more of the members in the plurality of members. The multichannel attribution report is presented to a user via a user interface device, such as, but not limited to, the UI device 110 on computing device 102 and/or the UI 122 on the user device 116.

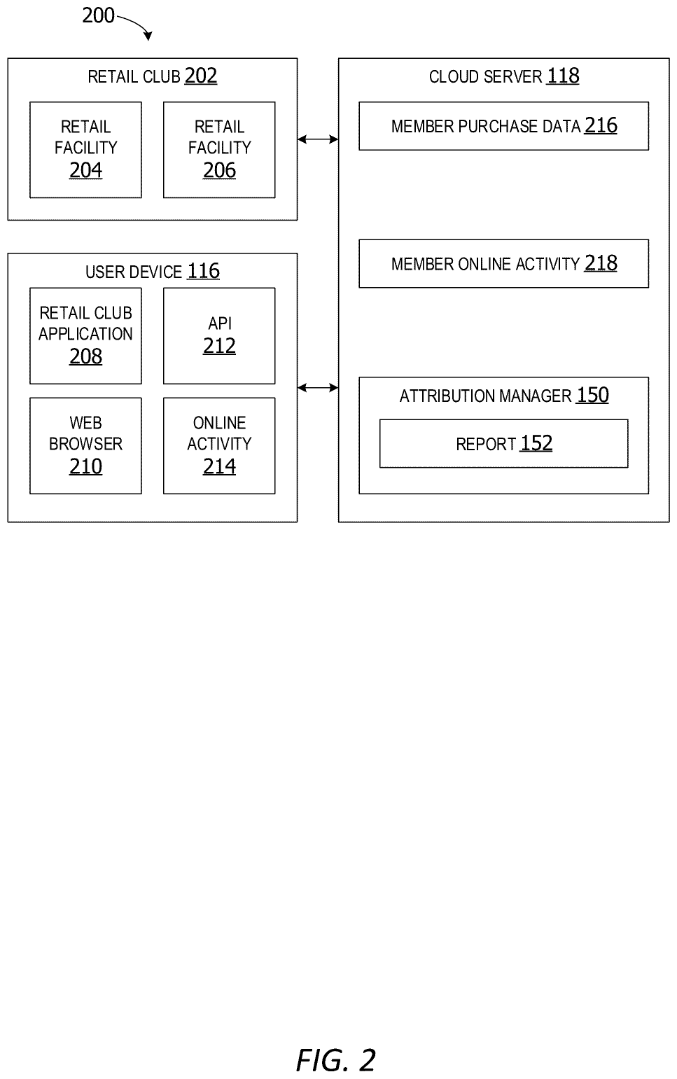

FIG. 2 is an exemplary block diagram illustrating a system 200 for multichannel attribution using member-related data associated with members of a retail club. In some examples, a retail club 202 includes one or more physical brick-and-mortar retail facilities in which members purchase products in person using the member ID 142 or other membership identifier, such as a membership card or member identification including the member ID 142. In this example, the retail club 202 includes a first retail facility 204 and a second retail facility 206. However, the examples are not limited to two retail facilities associated with the retail club 202. In other examples, the retail club 202 includes a single retail facility as well as a plurality of facilities. For example, the retail club 202 can include hundreds of retail facilities in multiple states and/or multiple nations. In another example, the retail club 202 can include three facilities or twenty facilities. In other words, the retail club can include a single facility as well as multiple national or international retail store locations.

The user device 116 in some examples includes a retail club application 208 which enables the user to view featured items and purchase items from the retail club online. In these examples, an application programming interface (API) 212 enables the user device to access the webpage and other online information associated with featured items sponsored by a merchant, manufacturer, distributor, or other producer of items offered for sale by the retail club 202. In other examples, a featured item may be sponsored by a retail facility or the retail club 202 itself.

In some examples, a member utilizes a web browser 210 to access a webpage of the retail club 202, such as, but not limited to, the webpage 124 in FIG. 1. The user's online activity 214 via the web browser 210 and/or retail club application 208 includes views (impressions) of the featured item entry via a UI and/or clicks on the featured item entry.

The cloud server 118 obtains member purchase data 216 from each retail facility computing system(s). The retail facility computing system includes a computing device, such as, but not limited to, the computing device 102 in FIG. 1 and/or the user device 116. The member purchase data 216 is pushed to the cloud server 118 in this example. In other examples, the attribution manager 150 on the cloud server 118 requests (pulls) the member purchase data 216 from the retail facility computing system(s). The attribution manager 150 obtains member online activity 218 from the web server hosting the retail club webpage and/or from the user device(s) accessing the webpage, such as the user device 116. The member online activity 218 includes member views (impressions), and member clicks on featured item entries presented via the retail club application and/or one or more webpages associated with the retail club.

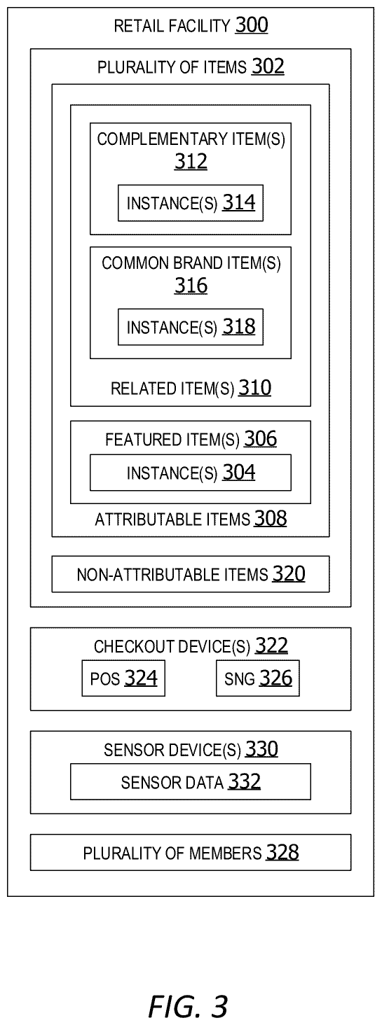

FIG. 3 is an exemplary block diagram illustrating a retail facility 300 associated with offline purchase of items by members. The retail facility 300 is a physical brick-and-mortar store associated with offline purchase of items by a plurality of members 328 of the retail club, such as, but not limited to, the retail facility 204 and/or the retail facility 206 in FIG. 2.

The retail facility 300 is a physical store having a plurality of items 302 for purchase. The retail facility 300 in some examples includes the interior of a building and/or the exterior of a building. For example, the retail facility 300 can include an indoor area displaying grocery items, electronics, pet supplies, etc. The retail facility 300 can also include an outdoor area or area which is partially enclosed and partially unenclosed for storing plants, garden supplies, yard furniture, portable storage sheds, playground equipment, etc.

The plurality of items 302 includes one or more instance(s) 304 of one or more featured item(s) 306 featured on a webpage or other search results of the retail club. Attributable items 308 are items which are ascribable to a featured item. The set of one or more attributable items 308 includes the featured item(s) 306 and one or more related item(s) 310. A related item is an item which is different than the featured item but associated with the featured item. The related item(s) 310 include complementary item(s) 312. A complementary item is an item which is frequently purchased or used in combination with the featured item. Therefore, purchase of instance(s) 314 of the complementary item(s) 312 are attributable to online activity associated with the featured item(s) 306.

The related item(s) 310 in other examples include common brand item(s) 316. A common brand item is an item of the same type and brand as the featured item but a different variety. The type of item indicates a category of an item. The type can include milk, soft drinks, bacon, tennis shoes, lawn mower, or any other type of item. The brand refers to the maker or manufacturer. For example, if the featured item is whole milk of a given brand B, then two percent (2%) low fat milk of the same brand B is a common brand item of a different variety than the featured item. Thus, member purchases of instance(s) 318 of one or more common brand item(s) 316 are attributable to online activity associated with the featured item(s). The non-attributable items 320 include one or more items in the plurality of items 302 which are not attributable to a featured item.

In some examples, the retail facility 300 includes checkout device(s) 322 used to complete a purchase of one or more instances of items in the retail facility 300. The checkout device(s) can include a POS 324 and/or SNG 326 device. A POS is a point-of-sale device at which a user completes a purchase transaction. A POS device typically includes a processor, memory, scanner device for scanning product identifiers, and a user interface for displaying item prices and total purchase price to the customer. A product identifier can include a universal product code (UPC) barcode, matrix barcode, radio frequency identifier (RFID) tag, a price tag, a product serial number, or any other type of item identification. The POS may be staffed or unstaffed. An SNG is a self-checkout type of POS at which a customer can scan items and/or the items are scanned automatically using scanner devices, imaging devices, RFID tag readers or other devices for identifying items in a customer basket, calculating a total purchase price, and accepting payment from the customer. A member may also purchase items via an online purchase using an application or webpage.

The retail facility 300 optionally also includes a set of one or more sensor device(s) 330 generating sensor data 332 associated with the plurality of items 302. The sensor device(s) 330 include scanner devices for scanning tags on items and/or shelves within the retail facility, such as a UPC tag, radio frequency identifier (RFID) tag, matrix barcode, or any other type of tag. The sensor data is used to identify items scanned at time of checkout during completion of a purchase transaction.

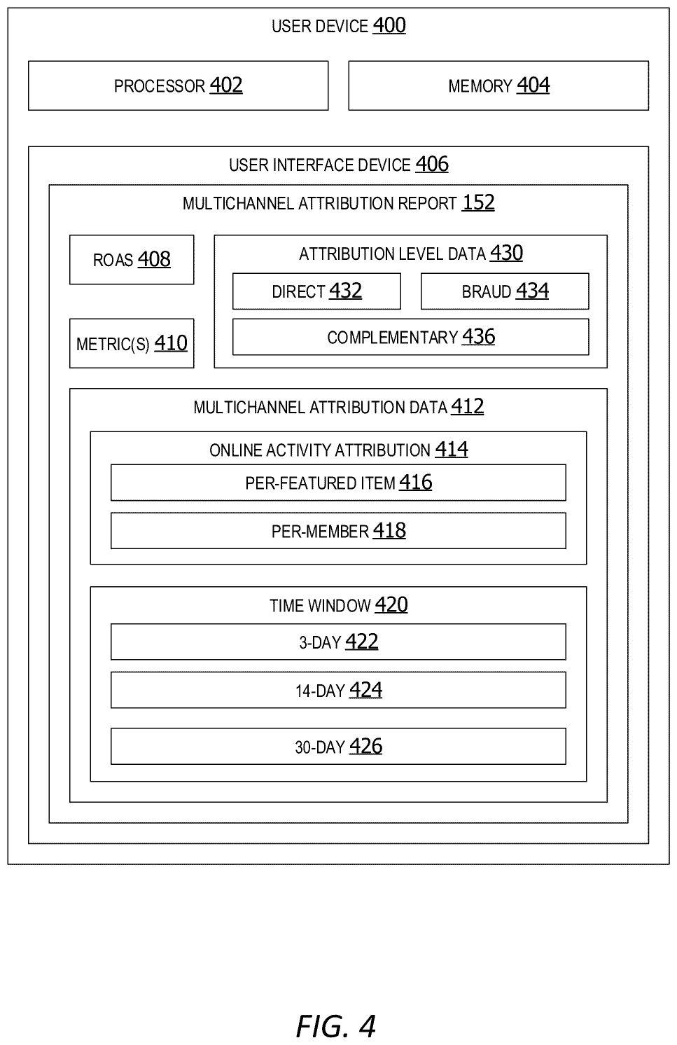

FIG. 4 is an exemplary block diagram illustrating a user device 400 including a user interface (UI) for displaying a multichannel attribution report. The user device is a computing device, such as, but not limited to, the user device 116 in FIG. 1. In some examples, the user device 400 includes a processor 402, a memory 404 and a device 406. The user device 400 receives the multichannel attribution report 152 from the attribution manager. The multichannel attribution report 152 includes data associated with the ROAS 408, metric(s) 410 and/or other multichannel attribution data 412. The ROAS 408 indicates return on investment with regard to the amount spent by an advertiser or other promotor for an item to be featured (sponsored) on the webpage and/or in the search results relative to the increase in revenue from purchased items attributable to the featured item. The metric(s) 410 include one or more metrics for measuring ROAS 408 and other attribution data, such as percentage increase in revenue, dollar amount of increase in revenue, etc.

The multichannel attribution data 412 includes online activity attribution 414 per-featured item 416. In other words, the attribution of purchased items to online activity for each separate featured item. Thus, if three items are featured at one time, attribution is performed separately for each featured item. Attribution in other examples is performed for two or more featured items.

The attribution in other examples includes per-member 418 attribution in which purchase data for each member is correlated to online activity separately from other members. In other examples, attribution is performed for multiple members together. In other words, all the purchase data for all members purchasing featured items and related items are aggregated together for determination of attribution data for each item.

The multichannel attribution data 412 in other examples includes a time-window 420 during which attributable items are purchased by members following online activity associated with a featured item, such as clicks and/or views of featured item entries. In this example, the time window includes a three day (3-day) 422 time window, a fourteen day (14-day) 424 time window and/or a thirty day (30-day) 426 time window. For example, if a member purchases a featured item two days after viewing a featured item entry, the time window 420 includes all three of the time windows because the featured item was purchased prior to all three time windows.

In another example, if a member purchases a featured item ten days after clicking on a featured item entry, the purchase falls within both the 14-day 424 time window and the 30-day 426 time window. Likewise, if a member purchases a featured item twenty-five days after viewing a featured item entry, the attribution of the purchase to the online activity falls within only the 30-day 426 time window. However, the examples are not limited to the time windows shown in FIG. 4. The time window for attributions includes any user-configurable period of time following online activity. Thus, in other examples, a time window optionally includes a sixty-day time window, a two-day time window, a twenty-one-day time window or any other time period.

Thus, when an item is featured on a club website as a sponsored product, customers view the featured item entry and/or click on the featured item entry. If customers purchase instances of the featured item or a related item within the 3-day window, the 14-day window or the 30-day window, the system attributes the online activity (views/clicks) of club members to the featured item (sponsored product). The attribution indicates the amount of revenue boost attributable to the featured item entry, such as a sponsored ad or prominent placement of the featured item entry.

In some examples, the multichannel attribution report 152 includes user-configurable data, such as attribution data based on purchases at specific brick-and-mortar locations, attribution data for purchases made within specific user-configured time-periods, attribution data for purchases made via specific purchase channels, etc. In these examples, the user selects user-configurable settings or parameters used when generating the report. The user-configurable parameters specify parameters for calculating the attributions and/or classifying the attribution data into categories. In some examples, the user-configurable parameters include duration (maximum threshold time) for the time window. In these examples, the user selects a time window setting specifying a length of time after online activity occurs during which purchases of instances of the featured item and/or related items is considered for calculating attribution data for inclusion in the multichannel attribution report.

In some examples, a user may wish to set a longer maximum threshold time following online activity associated with a featured item that is a larger item or a more expensive item. For example, an appliance like a clothes dryer or a computer is an item which typically involves a longer time period for customers to consider the purchase before buying the item due to the size and cost of the item. Therefore, a longer time window may be appropriate for attribution. A smaller or less expensive item like a t-shirt typically involves a shorter decision-making process for customers. Therefore, a shorter threshold time window may be appropriate.

In other examples, the user-configurable parameters include a user configurable geographic range or selected locations for use in identifying purchases of instances of the attributable items by members. For example, a user can specify that purchase data is only gathered for purchases made at brick-and-mortar retail facilities associated with the retail club within selected state(s) and/or selected countries. This limits the geographic area in which purchase data is obtained from retail facilities for use in calculating attribution data included in the attribution report.

In still other examples, a user-configurable setting includes the modality of online activity. In these examples, the user can specify whether the system should monitor only views/impressions, monitor only clicks, and/or monitor for both views and clicks associated with featured items.

The attribution level data 430 includes attribution data associated with each attribution level. The attribution levels include direct 432 attribution, brand 434 level attribution, and/or complementary 436 attribution. In these examples, the attribution data includes attribution data for instances of the featured item only (direct 432), attribution data for instances of complementary items (complementary 436) only, attribution data for instances of common brand items (brand 434), attribution data for related items including both complementary items and common brand items, and/or attribution data for instances of all attributable items including the featured item, complementary items, and common brand items.

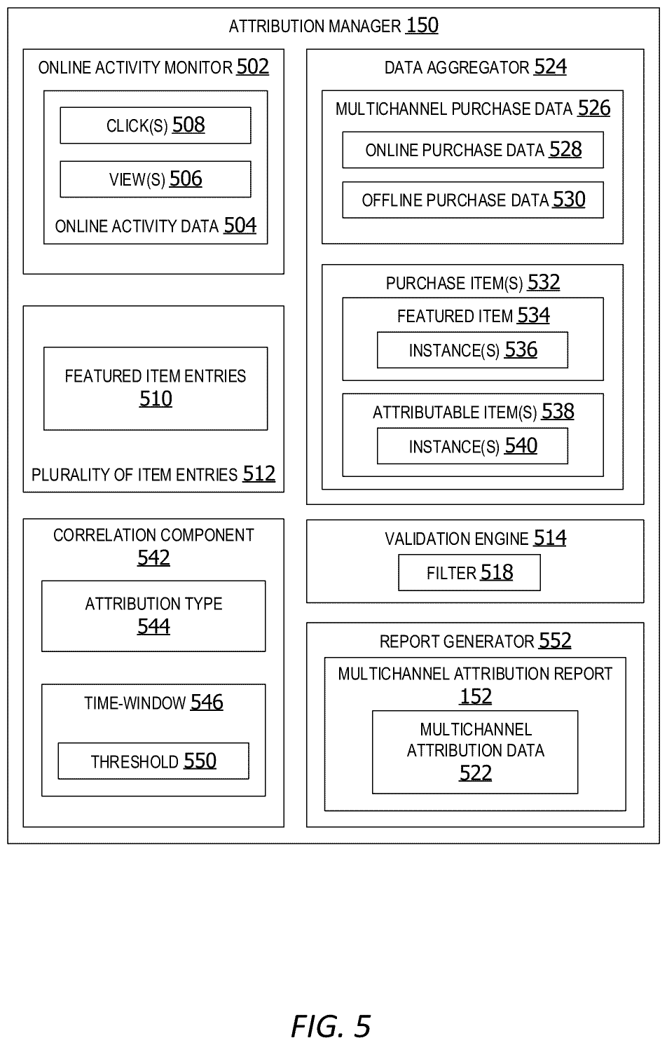

FIG. 5 is an exemplary block diagram illustrating an attribution manager 150 for correlating multichannel purchase data with member-related online activity data. In some examples, the attribution manager 150 includes an online activity monitor 502. The online activity monitor 502 monitors online activity by members of the retail club, such as view(s) 506 of online featured item entries 510 in a plurality of item entries 512 and click(s) 508 on the featured item entries. The online activity monitor 502 generates online activity data 504 recording the click(s) and view(s) by the members. In some examples, the online activity data is saved with the member ID for each member associated with the online click(s) and view(s).

In other examples, a validation engine 514 analyzes online activity data 504 using machine learning (ML). The ML function of the validation engine 514 includes pattern recognition, modeling, or other machine learning algorithms to analyze sensor data and/or database information to identify online activity associated with non-human entities, such as bots or other software application programmed to perform a task, such as clicking on a featured item entry in a webpage. The validation engine 514 includes a filter 518 to filter the online activity data to remove online activity data associated with the non-human entities. The filtered online activity data 504 includes online activity which is most likely associated with a human user, such as a member of the retail club. The filtered online activity data is used is used to generate the multichannel attribution data 522.

In this example, the online activity monitor generates the online activity data 504. However, in other examples, the attribution manager 150 pulls the online activity data 504 from a data store rather than generating the online activity data 504. In these examples, the online activity data is stored in a data store, such as, but not limited to, the data storage device 132 in FIG. 1.

In other examples, a data aggregator 524 obtains multichannel purchase data 526 for a set of attributable items associated with the featured item. The multichannel purchase data includes online purchase data 528 and offline purchase data 530. In this example, the multichannel purchase data 526 is obtained from a data store using a member identifier (ID) for each member in the plurality of members. The set of attributable items includes the featured item and a set of items related to the featured item. The purchased item(s) 532 described in the multichannel purchase data 526 includes instance(s) 536 of the featured item 534. In other examples, the multichannel purchase data 526 includes data associated with the purchase of instance(s) 540 of attributable item(s) 538 purchased both online and offline by members of the club. The attributable item(s) include instances of the featured item and instances of related items, such as complementary items and common brand items.

The attribution manager 150 includes a correlation component 542 that correlates the online activity with the multichannel purchase data 526 for the set of attributable items. The attribution manager 150 optionally correlates the purchases with online activity based on attribution type 544 and/or attribution time window 546. The attribution type 544 includes direct attribution, complementary attribution, and/or common brand level attribution.

The time window 546 is used to attribute item purchases occurring within a given amount of time after the online activity associated with the featured item entry. In other examples, the time window 546 is used to filter purchases occurring outside a threshold 550 maximum time period after the online activity. In this manner, the system filters out purchases which occur too long after the online activity. Thus, the system only considers purchases occurring after the online activity but before the threshold maximum amount of time following the online activity.

In other examples, a report generator 552 creates the multichannel attribution report 152. In some examples, the report includes the multichannel attribution data 522 associated with purchases of instances of items in the set of attributable items by the plurality of members correlated with the online activity of the plurality of members. The multichannel attribution report is presented to a user via the UI device.

FIG. 6 is an exemplary flow chart illustrating operation of the computing device to generate multichannel attribution reports. The process shown in FIG. 6 is performed by an attribution manager component, executing on a computing device, such as the computing device 102 or the user device 116 in FIG. 1.

The process begins by monitoring member online activity associated with featured item(s) at 602. The attribution manager generates online activity data at 604. The attribution manager obtains multichannel purchase data at 606. The online activity data is correlated with the multichannel purchase data by the attribution manager at 608. The attribution manager generates multichannel attribution data associated with a featured item at 610. The attribution manager generates a multichannel attribution report at 612. A determination is made whether to continue at 614. If yes, the process iteratively executes operations 602 through 612 until the determination is made not to continue at 614. The process terminates thereafter.

FIG. 7 is an exemplary flow chart illustrating operation of the computing device for attribution of multichannel purchase data with member-related online activity data. The process shown in FIG. 7 is performed by an attribution manager component, executing on a computing device, such as the computing device 102 or the user device 116 in FIG. 1.

The process begins by obtaining multichannel purchase data at 702. The data is obtained from a data store storing the online activity data, such as, but not limited to, the data storage device 132 in FIG. 1. The attribution manager obtains multichannel online activity data at 704. The multichannel online activity data is retrieved from a data store. The data store, in some examples, is the same data store storing the purchase data. In other examples, the multichannel purchase data is stored in a first data store and the online activity data is stored in a different second data store. The attribution manager identifies purchase of instances of a featured item within a threshold time after online activity associated with the featured item at 706. The attribution manager identifies purchase of instances of related item(s) within the threshold time at 708. The attribution manager correlates purchase of attributable items including instances of the featured item and related items with the online activity at 710. The process terminates thereafter.

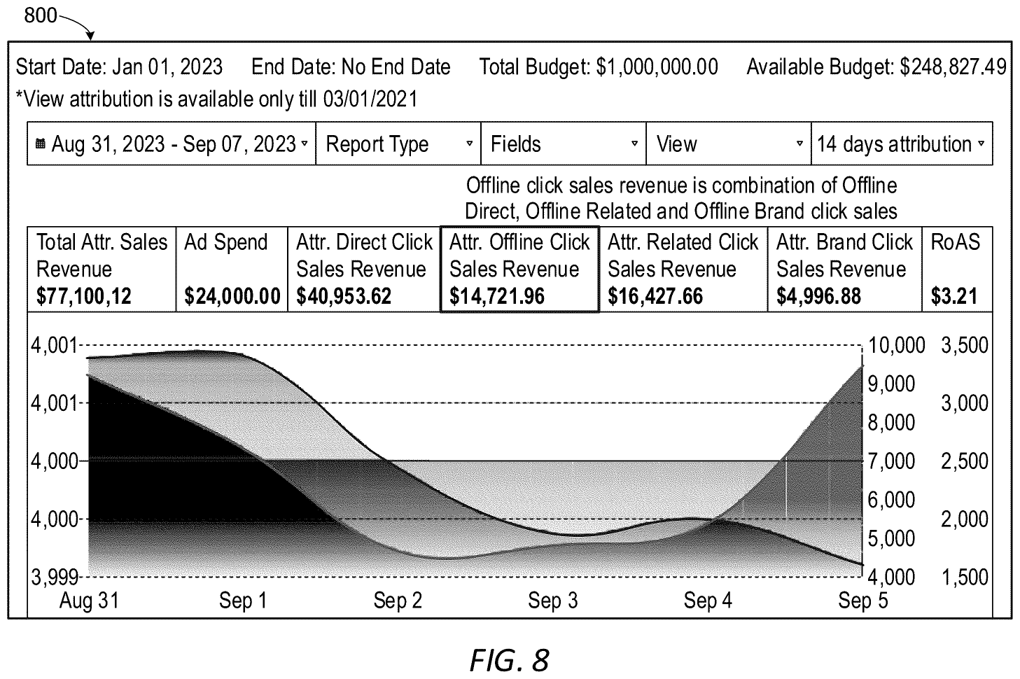

FIG. 8 is an exemplary diagram illustrating a multichannel attribution report 800. The multichannel attribution report 800 is a report including attribution data, such as, but not limited to, the multichannel attribution report 152 in FIG. 1. In this example, the attribution report 800 includes total attribution sales revenue, ad spend, direct click sales revenue, attribution for related (complementary) click sales revenue, attribution for common brand click sales revenue, and/or ROAS.

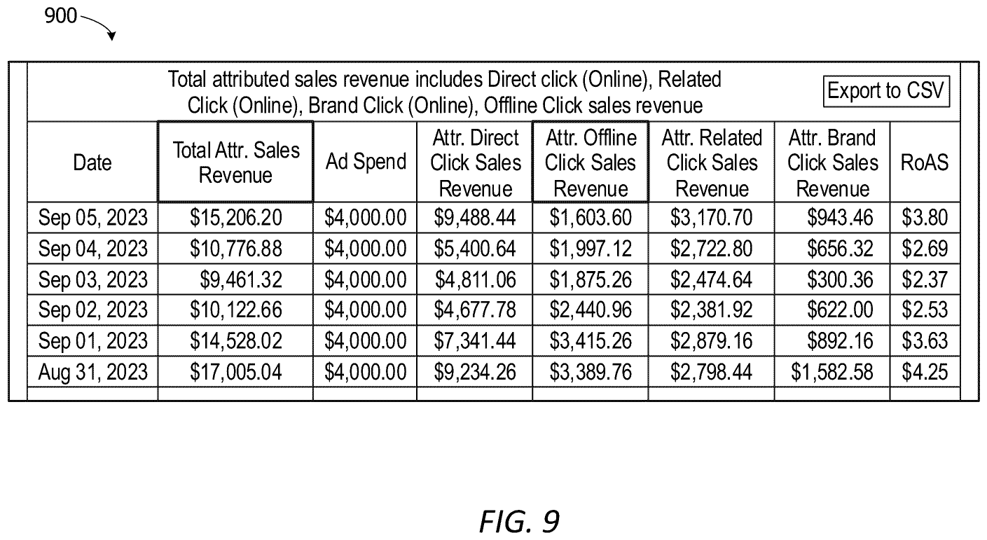

FIG. 9 is an exemplary table 900 illustrating total attributed sales revenue associated with an item. The table 900 includes data associated with direct click (online), related click (online), brand click (online), and offline click sales revenue for the featured item.

In some examples, the multichannel attribution system described in the examples above results in more accurate attribution for ROAS by tracking sales for products across all purchase channels, including both online and offline purchases by club members. In one example, the system attribution for a soft drink product showed an increase of twenty-four (24%) across ROAS/sales with offline sales added into the attribution data. In another example, the system resulted in a thirty-five percent (35%) increase across ROAS/sales for a food product by taking offline purchase by members into account. In yet another example, the system attribution resulted in a twenty percent (20%) increase in ROAS for another product with attribution of offline sales in addition to the online sales to members. In still another example, seventeen percent (17%) of sales through in-club attributed sales increased manual ROAS from $3.45 to $4.14 and automatic ROAS from $1.96 to $2.35.

In this example, the multichannel attribution report 800 is generated using multichannel purchase data describing both online purchases and offline purchases by members of the club as well as multichannel online activity data obtained from desktop computer web browsers, applications, mobile web as well as any other source of online activity data.

In this example, the multichannel attribution report 800 includes attribution data generated using both online purchase data and offline purchase data. In other words, the attribution data in the multichannel attribution report 800 reflects both online purchases of featured items by members as well as offline purchases of items in brick-and-mortar stores. However, the examples are not limited to multichannel attribution reports including both online and offline purchase data. In other examples, the multichannel attribution report 800 includes offline purchase data without online purchase data. In these examples, the attribution data in the multichannel attribution report is generated based on offline purchases by members occurring within brick-and-mortar stores, including purchases via staffed POS devices, unstaffed self-checkout devices, as well as any other type of checkout devices associated with the brick-and-mortar stores.

The attribution report shown in FIG. 8 above is an example of a multichannel attribution report. The examples are not limited to the types of data and categories of attribution data shown in the examples. In some examples, a multichannel attribution report optionally includes less information than is shown in FIG. 8. In other examples, a multichannel attribution report includes additional categories and/or types of information not shown in the multichannel attribution report 800.

### Additional Examples

In some examples, the system provides in-club (in-store) attribution for featured items, such as sponsored products. The in-club attribution is a differentiator for the member access platform (MAP) business by providing a mechanism to attribute offline (in-club) sales to featured item entries, such as digital ads, which are viewed and clicked online by club members. By recording metrics on offline attribution, the system provides a holistic picture to sponsors and advertisers on the value proposition attained as a result of investing in sponsored products and other promotions with the club and member access platform.

In other examples, the system consists of an event click stream component (online activity monitor) that tracks online activity of club members (user views and clicks) and data pipelines that retrieve the existing club orders placed via point of sale (POS) checkout devices and shop and go (SNG) self-checkout devices. The system uses the attribution pipeline to attribute purchases made both online and offline with the tracked online activity.

In other examples, the system leverages club membership as an identifier to correlate online clicks to offline purchases. Order pipelines are created and used to collate order information across different purchase channels, including both online purchase channels and offline purchase channels (SNG and POS) and attributes the member online activity (views and clicks) across different channels-Desktop, Mobile Web, and Mobile Apps. The system generates an attribution report, providing a complete view of the metrics for return on ad spend (ROAS) as opposed to online orders only. The attribution report indicates offline revenue contribution attributable to the featured item entry displayed on the website of the retail club. In other examples, the report indicates types of attribution, time window, as well as revenue attribution for each ad/sponsored product entry.

In some examples, online activity data for members is obtained from the website and matched with club members using user login data and/or member ID provided during searching on the website and/or purchase of products.

In other examples, the system includes ads (digital advertisement) attribution that works by correlating a customer's purchases to the online ad views and clicks they have performed earlier in the journey. The system tracks/correlates purchases made in physical club locations in addition to online purchases. In this manner, the system tracks all purchase channels, including POS and SNG. The system is able to correlate the purchases made as a result of clicking ads seen by the customer earlier in the journey. This is helpful for the advertiser as they are able to see the increase in the return for each dollar that they have spent on featured items.

In other examples, the system attributes a member's earlier online searches with subsequent purchases in a club. This is very helpful for sponsored products as it can provide a more accurate estimate of ROAS for the sponsors. The system also makes use of product hierarchy to identify if a member searched for a large red shirt and subsequently purchased a large blue shirt in the club (product variants).

Alternatively, or in addition to the other examples described herein, examples include any combination of the following:
the set of items related to the featured item comprises a set of complementary items and a set of common brand items associated with the featured item;
the online purchase data comprises purchase data associated with online purchase of instances of items in the set of attributable items by members in the plurality of members;
the offline purchase data comprises in-club purchase data associated with purchase of instances of the items in the set of attributable items at a retail facility associated with the retail club;
generate direct attribution data correlating online activity of at least one member with purchase of instances of the featured item;
generate brand attribution data correlating online activity of at least one member in the plurality of members with purchase of instances of at least one item having a same brand, same type, and different variety as the featured item;
generate complementary attribution data correlating online activity of at least one member in the plurality of members with purchase of at least one instance of at least one complementary item associated with the featured item;
the multichannel attribution report comprises the direct attribution data, the brand attribution data, and the complementary attribution data;
identify increase in revenue attributable to the featured item entry for each attribution time window in a set of attribution time windows;
the set of attribution time windows comprising a first time window, a second time window and a third time window;
generate the multichannel attribution report, including attribution data associated with purchase of instances of items in the set of attributable items occurring within the first time window, attribution data associated with purchase of instances of items in the set of attributable items within the second time window, and attribution data associated with purchase of instances of items in the set of attributable items within the third time window;
identify a member identifier (ID) associated with a member in the plurality of members;
obtain online activity data of the member associated with the featured item using the member ID;
retrieve purchase data associated with the member using the member ID, the purchase data including items purchased by the member via online purchase and offline purchase;
identify instances of attributable items purchased by the member using the purchase data;
correlate purchase of an instance of an attributable item to a view or click of the featured item entry by the member within the predetermined time-period prior to the purchase;
generate attribution data for the member using the correlated purchase;
analyze online activity data using machine learning;
identify online activity associated with non-human entities;
filter the online activity data, wherein filtering removes online activity data associated with the non-human entities;
wherein the filtered online activity comprises online activity which is most likely associated with a human user;
wherein the filtered online activity is used is used to generate the multichannel attribution data;
monitoring online activity associated with a featured item by a plurality of members of a retail club, the featured item associated a featured item entry within a webpage;
generating online activity data describing the monitored online activity associated with the featured item entry, the monitored online activity comprising a number of views of the featured item entry and a number of clicks on the featured item entry by the plurality of members occurring within a predetermined time-period;
obtaining multichannel purchase data for a set of attributable items associate with the featured item, the set of attributable items comprising the featured item and a set of items related to the featured item, the multichannel purchase data comprising online purchase data and offline purchase data;
correlating the online activity data with the multichannel purchase data for the set of attributable items;
generating multichannel attribution data associated with the featured item describing online activity correlated with purchase of instances of items in the set of attributable items;
creating a multichannel attribution report describing item purchases attributable to the featured item entry across multiple purchase channels, the multichannel attribution report presented to a user via a user interface device;
identifying a set of items complementary to the featured item, wherein a complementary item is a different item from the featured item, and wherein the complementary item is frequently utilized in conjunction with the featured item;
adding the set of complementary items to the set of attributable items, wherein the multichannel attribution report includes purchase data associated with the set of complementary items correlated with the online activity associated with the featured item entry;
identifying a set of common brand items, wherein a common brand item is an item of a same brand, same type, and different variety than the featured item;
adding the set of common brand items to the set of attributable items, wherein the multichannel attribution report includes purchase data associated with the set of common brand items correlated with the online activity associated with the featured item entry;
generating direct attribution data identifying purchases of instances of the featured item correlated with the online activity of at least one member in the plurality of members, wherein the multichannel attribution report includes the direct attribution data;
generating brand attribution data correlating online activity of at least one member in the plurality of members with purchase of instances of at least one item having a same brand, same type, and different variety as the featured item;
wherein the multichannel attribution report includes direct attribution data and the brand attribution data;
generating complementary attribution data correlating online activity of at least one member in the plurality of members with purchase of at least one instance of at least one complementary item associated with the featured item;
wherein the multichannel attribution report includes direct attribution data and the complementary attribution data;
identifying a time window in a set of time windows associated with purchase of instances of items in the set of attributable items;
wherein the multichannel attribution report includes attribution data associated with instances of items in the set of attributable items purchased during each time window in the set of time windows;
monitor online activity associated with a featured item by a plurality of members of a retail club, the featured item associated a featured item entry within a webpage;
generate online activity data describing the monitored online activity associated with the featured item entry;
the monitored online activity comprising a number of views of the featured item entry and a number of clicks on the featured item entry by the plurality of members occurring within a predetermined time-period;
obtain multichannel purchase data for a set of attributable items associate with the featured item, the set of attributable items comprising the featured item and a set of items related to the featured item;
the multichannel purchase data comprising online purchase data and offline purchase data;
wherein the offline purchase data comprises in-club purchase data associated with purchase of instances of the items in the set of attributable items at a retail facility associated with the retail club;
generate multichannel attribution data associated with the featured item describing online activity correlated with purchase of instances of items in the set of attributable items;
generate a multichannel attribution report describing item purchases attributable to the featured item entry across multiple purchase channels;
present the multichannel attribution report to a user via a user interface device;
identify a set of items complementary to the featured item, wherein a complementary item is a different item from the featured item, and wherein the complementary item is frequently utilized in conjunction with the featured item;
add the set of complementary items to the set of attributable items, wherein the multichannel attribution report includes purchase data associated with the set of complementary items correlated with the online activity associated with the featured item entry;
identify increase in revenue attributable to the featured item entry for each type of attribution in a set of attribution types, the set of attribution types comprising direct attribution, common brand attribution, and complementary attribution;
generate the multichannel attribution report, including attribution data associated with direct attribution, attribution data associated with common brand attribution, and attribution data associated with complementary brand attribution;
identifying a time window in a set of time windows associated with purchase of instances of items in the set of attributable items;
wherein the multichannel attribution report includes attribution data associated with instances of items in the set of attributable items purchased during each time window in the set of time windows;
wherein the set of time windows includes a first time window, a second time window and a third time window;
wherein the second time window includes a longer period of time than the first time window, and wherein the third time window includes a longer period of time than the second time window; and
verify online activity data using machine learning to eliminate online activity likely performed by a non-human entity, wherein verified online activity data is data attributable to human users, wherein the verified online activity data is used to correlate purchase of instances of items in the set of attributable items with the online activity associated with the featured item entry.

At least a portion of the functionality of the various elements in FIG. 1, FIG. 2, FIG. 3, FIG. 4, and FIG. 5 can be performed by other elements in FIG. 1, FIG. 2, FIG. 3, FIG. 4, and FIG. 5, or an entity (e.g., processor 106, web service, server, application program, computing device, etc.) not shown in FIG. 1, FIG. 2, FIG. 3, FIG. 4, and FIG. 5.

In some examples, the operations illustrated in FIG. 6 and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of multichannel attribution, the method comprising monitoring online activity associated with a featured item entry within a webpage by a plurality of members, the online activity including featured item entry views and featured item entry clicks; validating the online activity data; obtaining multichannel purchase data for a set of attributable items associate with the featured item from a data store using a member identifier (ID) for each member in the plurality of members, the set of attributable items comprising the featured item and a set of items related to the featured item, the multichannel purchase data comprising online purchase data and offline purchase data; correlating the online activity with the multichannel purchase data for the set of attributable items; and creating a multichannel attribution report including multichannel attribution data associated with purchases of instances of items in the set of attributable items by the plurality of members correlated with the online activity of the plurality of members, the multichannel attribution report presented to a user via a user interface device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for multichannel attribution for featured items using member offline purchase data. For example, the elements illustrated in FIG. 1, FIG. 2, FIG. 3, FIG. 4, and FIG. 5, such as when encoded to perform the operations illustrated in FIG. 6 and FIG. 7, constitute exemplary means for monitoring online activity associated with a featured item entry within a webpage by a plurality of members; exemplary means for obtaining multichannel purchase data for a set of attributable items associate with the featured item from a data store using a member identifier (ID) for each member in the plurality of members; exemplary means for correlating the online activity with the multichannel purchase data for the set of attributable items; and exemplary means for creating a multichannel attribution report including multichannel attribution data associated with purchases of instances of items in the set of attributable items by the plurality of members correlated with the online activity of the plurality of members.

Other non-limiting examples provide one or more computer storage devices having a first computer-executable instructions stored thereon for providing multichannel attribution for featured items using offline purchase data. When executed by a computer, the computer performs operations including obtaining multichannel online activity data associated with a featured item entry within a webpage by a plurality of members, the online activity including featured item entry views and featured item entry clicks; obtaining multichannel purchase data for a set of attributable items associate with the featured item from a data store; correlating the online activity with the multichannel purchase data for the set of attributable items; and creating a multichannel attribution report including multichannel attribution data associated with purchases of instances of items in the set of attributable items by the plurality of members correlated with the online activity of the plurality of members, the multichannel attribution report presented to a user via a user interface device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for multichannel in-club attribution, the system comprising:
a processor; and
a computer-readable medium storing instructions that are operative upon execution by the processor to:
monitor online activity associated with a featured item entry within a webpage by a plurality of members, the online activity including featured item entry views and featured item entry clicks;
obtain multichannel purchase data for a set of attributable items associate with the featured item entry from a data store using a member identifier (ID) for each member in the plurality of members, the set of attributable items comprising a featured item associated with the featured item entry and a set of items related to the featured item, the multichannel purchase data comprising online purchase data and offline purchase data;
correlate the online activity with the multichannel purchase data for the set of attributable items; and
create a multichannel attribution report including multichannel attribution data associated with purchases of instances of items in the set of attributable items by the plurality of members correlated with the online activity of the plurality of members, the multichannel attribution report presented to a user via a user interface device.

2. The system of claim 1, wherein the set of items related to the featured item comprises a set of complementary items and a set of common brand items associated with the featured item.

3. The system of claim 1, wherein the online purchase data comprises purchase data associated with online purchase of instances of items in the set of attributable items by members in the plurality of members, and wherein the offline purchase data comprises in-club purchase data associated with purchase of instances of the items in the set of attributable items at a retail facility associated with a retail club.

4. The system of claim 1, wherein the instructions are further operative to:
generate direct attribution data correlating online activity of a first member with purchase of an instance of the featured item;
generate brand attribution data correlating online activity of a second member in the plurality of members with purchase of an instance of an item having a same brand, same type, and different variety as the featured item; and
generate complementary attribution data correlating online activity of a third member in the plurality of members with purchase of an instance of a complementary item associated with the featured item, wherein the multichannel attribution report comprises the direct attribution data, the brand attribution data, and the complementary attribution data associated with the plurality of members.

5. The system of claim 1, wherein the instructions are further operative to:
identify increase in revenue attributable to the featured item entry associated with the webpage for each attribution time window in a set of attribution time windows, the set of attribution time windows comprising a first time window, a second time window and a third time window; and
generate the multichannel attribution report, including attribution data associated with purchase of instances of items in the set of attributable items occurring within the first time window, attribution data associated with purchase of instances of items in the set of attributable items within the second time window, and attribution data associated with purchase of instances of items in the set of attributable items within the third time window.

6. The system of claim 1, wherein the instructions are further operative to:
identify a member identifier (ID) associated with a member in the plurality of members;
obtain online activity data of the member associated with the featured item entry using the member ID;
retrieve purchase data associated with the member using the member ID, the purchase data including items purchased by the member via online purchase and offline purchase;
identify instances of attributable items purchased by the member using the purchase data;
correlate purchase of an instance of an attributable item to a view or click of the featured item entry by the member within a predetermined time-period prior to the purchase; and
generate attribution data for the member using the correlated purchase.

7. The system of claim 1, wherein the instructions are further operative to:
analyze online activity data using machine learning;
identify online activity associated with non-human entities; and
filter the online activity data, wherein filtering removes online activity data associated with the non-human entities, wherein the filtered online activity comprises online activity likely associated with a human user, and wherein the filtered online activity is used is used to generate the multichannel attribution data.

8. A method for multichannel in-club attribution, the method comprising:
monitoring online activity associated with a featured item entry by a plurality of members of a retail club, the featured item entry representing a featured item, the featured item entry associated with a webpage;
generating online activity data describing the monitored online activity associated with the featured item entry, the monitored online activity comprising a number of views of the featured item entry and a number of clicks on the featured item entry by the plurality of members occurring within a predetermined time-period;
obtaining multichannel purchase data for a set of attributable items associate with the featured item, the set of attributable items comprising the featured item and a set of items related to the featured item, the multichannel purchase data comprising online purchase data and offline purchase data;
correlating the online activity data with the multichannel purchase data for the set of attributable items;
generating multichannel attribution data associated with the featured item entry describing online activity correlated with purchase of instances of items in the set of attributable items; and
creating a multichannel attribution report describing item purchases attributable to the featured item entry across multiple purchase channels, the multichannel attribution report presented to a user via a user interface device.

9. The method of claim 8, further comprising:
identifying a set of items complementary to the featured item, wherein a complementary item is a different item from the featured item, and wherein the complementary item is frequently utilized in conjunction with the featured item; and
adding the set of items to the set of attributable items, wherein the multichannel attribution report includes purchase data associated with the set of items complementary to the featured item correlated with the online activity associated with the featured item entry.

10. The method of claim 8, further comprising:
identifying a set of common brand items, wherein a common brand item is an item of a same brand, same type, and different variety than the featured item; and
adding the set of common brand items to the set of attributable items, wherein the multichannel attribution report includes purchase data associated with the set of common brand items correlated with the online activity associated with the featured item entry.

11. The method of claim 8, further comprising:
generating direct attribution data identifying purchases of instances of the featured item correlated with online activity of at least one member in the plurality of members, wherein the multichannel attribution report includes the direct attribution data.

12. The method of claim 8, further comprising:
generating brand attribution data correlating online activity of at least one member in the plurality of members with purchase of instances of at least one item having a same brand, same type, and different variety as the featured item, wherein the multichannel attribution report includes direct attribution data and the brand attribution data.

13. The method of claim 8, further comprising:
generating complementary attribution data correlating online activity of at least one member in the plurality of members with purchase of at least one instance of at least one complementary item associated with the featured item, wherein the multichannel attribution report includes direct attribution data and the complementary attribution data.

14. The method of claim 8, further comprising:
identifying a time window in a set of time windows associated with purchase of instances of items in the set of attributable items, wherein the multichannel attribution report includes attribution data associated with instances of items in the set of attributable items purchased during each time window in the set of time windows.

15. One or more computer storage devices having computer-executable instructions stored thereon, which, upon execution by a computer, cause the computer to perform operations comprising:
monitor online activity associated with a featured item entry within a webpage by a plurality of members of a retail club, the featured item entry associated with a featured item;
generate online activity data describing the monitored online activity associated with the featured item entry, the monitored online activity comprising a number of views of the featured item entry and a number of clicks on the featured item entry by the plurality of members occurring within a predetermined time-period;
obtain multichannel purchase data for a set of attributable items associate with the featured item entry, the set of attributable items comprising the featured item and a set of items related to the featured item, the multichannel purchase data comprising online purchase data and offline purchase data, wherein the offline purchase data comprises in-club purchase data associated with purchase of instances of the items in the set of attributable items at a retail facility associated with the retail club;
generate multichannel attribution data associated with the featured item entry describing online activity correlated with purchase of instances of items in the set of attributable items; and
generate a multichannel attribution report describing item purchases attributable to the featured item entry across multiple purchase channels; and
present the multichannel attribution report to a user via a user interface device.

16. The one or more computer storage devices of claim 15, wherein the operations further comprise:
identify a set of complementary items, the set of complementary items comprising at least one item complementary to the featured item, wherein a complementary item is a different item from the featured item, and wherein the complementary item is frequently utilized in conjunction with the featured item; and
add the set of complementary items to the set of attributable items, wherein the multichannel attribution report includes purchase data associated with the set of complementary items correlated with the online activity associated with the featured item entry.

17. The one or more computer storage devices of claim 15, wherein the operations further comprise:
identify increase in revenue attributable to the featured item entry for each type of attribution in a set of attribution types, the set of attribution types comprising direct attribution, common brand attribution, and complementary attribution; and
generate the multichannel attribution report, including attribution data associated with direct attribution, attribution data associated with common brand attribution, and attribution data associated with complementary brand attribution.

18. The one or more computer storage devices of claim 15, wherein the operations further comprise:
identifying a time window in a set of time windows associated with purchase of instances of items in the set of attributable items, wherein the multichannel attribution report includes attribution data associated with instances of items in the set of attributable items purchased during each time window in the set of time windows.

19. The one or more computer storage devices of claim 18, wherein the set of time windows includes a first time window, a second time window and a third time window, wherein the second time window includes a longer period of time than the first time window, and wherein the third time window includes a longer period of time than the second time window.

20. The one or more computer storage devices of claim 15, wherein the operations further comprise:
verify online activity data using machine learning to eliminate online activity likely performed by a non-human entity, wherein verified online activity data is data attributable to human users, wherein the verified online activity data is used to correlate purchase of instances of items in the set of attributable items with the online activity associated with the featured item entry.
